(19) United States
(12) Patent Application Publication
(10) Pub. No.: US 2005/0259207 A1
(43) Pub. Date: Nov. 24, 2005

(54) Reflective type fringe field switching liquid crystal display

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/135,834

(22) Filed: May 23, 2005

(30) Foreign Application Priority Data
May 21, 2004 (TW) 93114424

(51) Int. Cl. G02F 1/1343; G02F 1/1335

(52) U.S. Cl. 349/141; 349/113

(57) ABSTRACT

A reflective type fringe field switching liquid crystal display (FFS LCD) (2) includes an upper and a lower substrates (21, 22) facing each other, and a liquid crystal layer (23) interposed between the upper and lower substrates. A plurality of gate lines (216) and a plurality of data lines (218) are associated with one of the upper and lower substrates, thereby defining a plurality of pixel regions. A common electrode (211) and a plurality of pixel electrodes (212) overlying the common electrode are disposed in the pixel regions in order to form at least one fringe electric field. At least one of the pixel electrodes in each pixel region has a bent portion in order to establish an electric field in at least two directions between the pixel electrodes and the common electrode in the pixel region. Accordingly, the reflective FFS LCD has a high quality, reliable display.

### FIELD OF THE INVENTION

The present invention relates to reflective type liquid crystal displays (LCDs), and more particularly to a reflective type fringe field switching (FFS) LCD.

### BACKGROUND

An LCD utilizes the optical and electrical anisotropy of liquid crystal molecules thereof in order to produce an image. The liquid crystal molecules have a particular passive orientation when no voltage is applied thereto. However, when a voltage is applied and the LCD is in a driven state, the liquid crystal molecules change their orientation according to the strength and direction of the driving electric field. A polarization state of incident light changes when the light transmits through the liquid crystal molecules, due to the optical anisotropy of the liquid crystal molecules. The extent of the change depends on the orientation of the liquid crystal molecules. Thus, by properly controlling the driving electric field, an orientation of the liquid crystal molecules is changed and a desired image can be produced.

The twisted nematic (TN) mode LCD was the first main type of LCD developed. Even though TN mode LCDs have been put into use in many applications, they have an inherent drawback that cannot be eliminated; namely, a very narrow viewing angle. By adding compensation films on TN mode LCDs, this problem can be mitigated to some extent. However, the cost of the TN mode LCD is increased. Therefore, an LCD with a totally different driving means has been developed. The LCD is called a fringe field switching (FFS) LCD. The FFS LCD has pixel and common electrodes usually arranged on two different layers of a same substrate. The distance between the electrodes is narrow, in order to form a fringe electric field about the electrodes.

Usually an LCD needs a planar light source, such as a backlight module, to display images. This kind of LCD is called a transmissive type LCD. In general, the backlight module is the main power consuming component of the transmissive type LCD. In order to reduce power consumption, reflective type LCDs have been developed. A reflective type LCD generally utilizes natural ambient light beams to provide a planar light source.

FIG. 7 is a perspective view showing orientations of liquid crystal molecules 130 in a conventional reflective type FFS LCD 1 when a voltage is applied thereto. The reflective FFS LCD 1 includes a lower substrate 11, an upper substrate 12 facing the lower substrate 11, and a liquid crystal layer 13 interposed between the substrates 11, 12. A common electrode 111, an insulating layer 113, a plurality of parallel pixel electrodes 112, and a lower alignment layer 114 are sequentially arranged on an inner surface of the lower substrate 11. An upper alignment layer 124 is arranged on an inner surface of the upper substrate 12. An upper polarizer 125 is arranged on an outer surface of the upper substrate 12.

As shown in FIG. 7, when a voltage is applied to the FFS LCD 1, the pixel electrodes 112 and the common electrode 111 form a fringe electric field to drive the liquid crystal molecules 130 of the liquid crystal layer 13, and to thus make the FFS LCD 1 display desired images.

Also referring to FIG. 8, this is a schematic, cross-sectional top view of pixel electrodes 112 and other components of the FFS LCD 1. A gate line 116 and a data line 118 are arranged on the lower substrate 11, and cross each other. A thin film transistor (TFT) 117 is disposed in the vicinity of the crossing of the gate line 116 and the data line 118. The gate line 116 is utilized to control the electrical switching of the TFT 117. The data line 118 provides electrical signals to the pixel electrodes 112. Each pixel electrode 112 is a linear electrode that is aligned along a single direction.

Because each pixel electrode 112 is a linear electrode that is aligned along a single direction, when a voltage is applied, a single direction electric field is established between the pixel and common electrodes 112 and 111. The liquid crystal molecules 130 are twisted so as to align according to the electric field. That is, long axes of the liquid crystal molecules 130 are oriented in a single direction only. This means that an associated display screen exhibits color shift when the display screen is obliquely viewed while displaying white.

What is needed, therefore, is a reflective type FFS LCD which has better viewing angle characteristics.

### SUMMARY

In a preferred embodiment, a reflective type fringe field switching liquid crystal display comprises an upper and a lower substrates facing each other, and a liquid crystal layer interposed between the upper and lower substrates. A plurality of gate lines and a plurality of data lines are associated with one of the upper and lower substrates, thereby defining a plurality of pixel regions. A common electrode and a plurality of pixel electrodes overlying the common electrode are disposed in the pixel regions in order to form at least one fringe electric field. At least one of the pixel electrodes in each pixel region has a bent portion in order to establish an electric field in at least two directions between the pixel electrodes and the common electrode in the pixel region.

In a second embodiment, a reflective type FFS LCD comprises an upper and lower substrates facing each other, and a liquid crystal layer interposed between the first and second substrates. A common electrode and a plurality of pixel electrodes overlying the common electrode are disposed on one of the upper and lower substrates in order to form one or more fringe electric fields. One of the pixel electrodes has a bent portion.

Thus, in each pixel region of the reflective FFS LCD, an electric field in at least two directions is generated between the pixel and common electrodes so as to form at least two domains. Accordingly, the reflective FFS LCD has a high quality, reliable display.

Other objects, advantages, and novel features will become more apparent from the following detailed description when taken in conjunction with the accompanying drawings, in which:

### BRIEF DESCRIPTION OF THE DRAWINGS

FIG. 1 is a schematic, side cross-sectional view of part of a reflective FFS LCD according to a first embodiment of the present invention;

FIG. 2 is a schematic, cross-sectional top elevation of parts of a pixel region of the reflective FFS LCD of FIG. 1, showing a configuration of pixel electrodes;

FIG. 3 is an enlarged view of a circled portion III of FIG. 2;

FIG. 4 is a schematic, side cross-sectional view of part of a reflective FFS LCD according to a second embodiment of the present invention;

FIG. 5 is a schematic, cross-sectional top elevation of parts of a pixel region of the reflective FFS LCD of FIG. 4, showing a configuration of pixel electrodes;

FIG. 6 is an enlarged view of a circled portion VI of FIG. 5;

FIG. 7 is a perspective view of a conventional reflective FFS LCD; and;

FIG. 8 is a schematic, cross-sectional top elevation of parts of a pixel region of the reflective FFS LCD of FIG. 7, showing a configuration of pixel electrodes.

### DETAILED DESCRIPTION OF PREFERRED EMBODIMENTS

Referring to FIG. 1, a reflective FFS LCD 2 according to a first embodiment of the present invention includes a lower substrate 21, an upper substrate 22 facing the lower substrate 21, and a liquid crystal layer 23 interposed between the substrates 21, 22. A common electrode 211 made of reflective electrically conductive material, an insulating layer 213, a plurality of parallel pixel electrodes 212, and a lower alignment layer 214 are sequentially arranged on an inner surface of the lower substrate 21. An upper alignment layer 224 is arranged on an inner surface of the upper substrate 22. An upper polarizer 225 is arranged on an outer surface of the upper substrate 22.

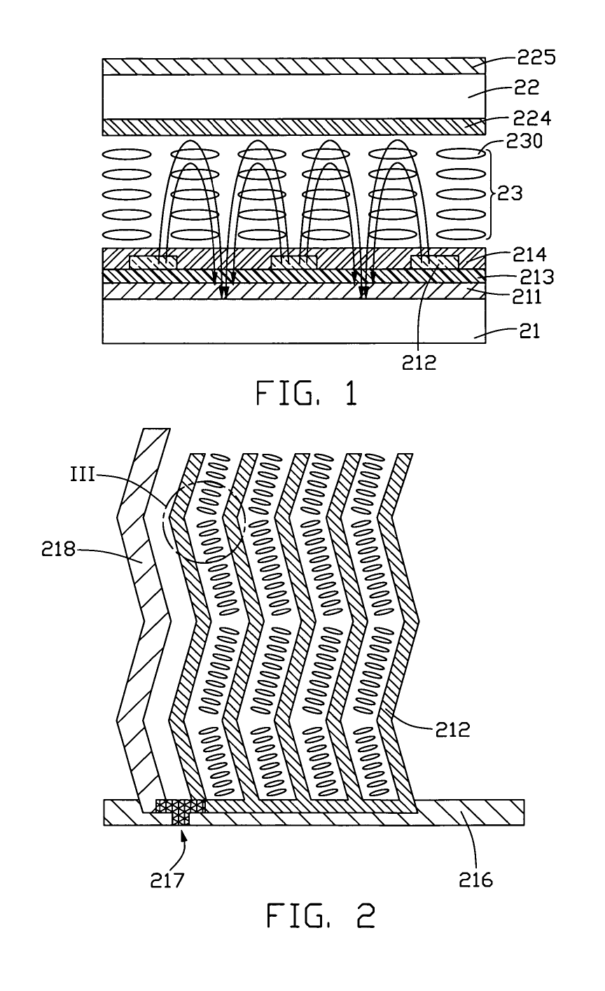

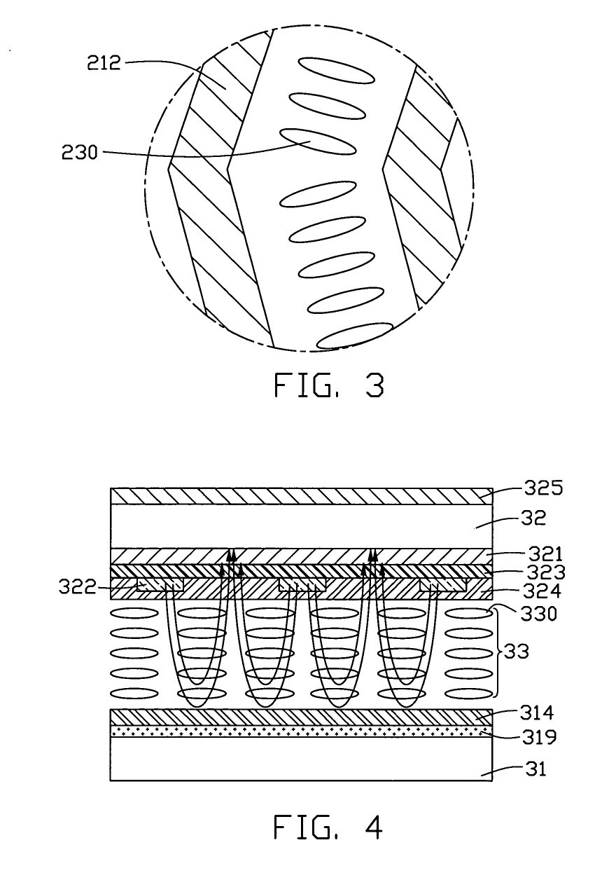

Referring to FIG. 2 and FIG. 3, a gate line 216 and a data line 218 are arranged on the lower substrate 21, and cross each other. A thin film transistor (TFT) 217 is disposed in the vicinity of the crossing of the gate line 216 and the data line 218. The gate line 216 is utilized to control the electrical switching of the TFT 217. The data line 218 provides electrical signals to the pixel electrodes 212. Each pixel electrode 212 has a generally zigzagged configuration, with the pixel electrodes 212 being parallel to each other. The data line 218 may also have a zigzagged configuration, whereby the data line 218 is parallel to the pixel electrodes 212.

When a voltage is applied to the reflective FFS LCD 2, the reflective FFS LCD 100 is in an on state. A fringe electric field distributing in at least two directions is generated between the pixel electrodes 212 and the common electrode 211 so as to form at least two domains. Liquid crystal molecules 230 are twisted so as to align according to the fringe electric field. That is, long axes of the liquid crystal molecules 230 are oriented in at least two directions. Accordingly, the FFS LCD 2 has a high quality, reliable display.

In addition, in the first embodiment, the common electrode 211 may be a transparent electrode. And a reflective layer may be interposed between the lower substrate 21 and the common electrode 211. Alternatively, the reflective layer may be also disposed on the outer surface of the lower substrate 21. Furthermore, in order to improve the reflective effect, a plurality of reflective bumps may be arranged on an inner surface of the reflective layer or the common electrode 211 made of reflective material.

Referring to FIG. 4, a reflective FFS LCD 3 according to a second embodiment of the present invention includes a lower substrate 31, an upper substrate 32 facing the lower substrate 31, and a liquid crystal layer 33 interposed between the substrates 31, 32. A common electrode 321, an insulating layer 323, a plurality of parallel pixel electrodes 322, and an upper alignment layer 324 are sequentially arranged on an inner surface of the upper substrate 31. A lower alignment layer 314 and a reflective layer 319 are sequentially arranged on an inner surface of the lower substrate 31. An upper polarizer 325 is arranged on an outer surface of the upper substrate 32.

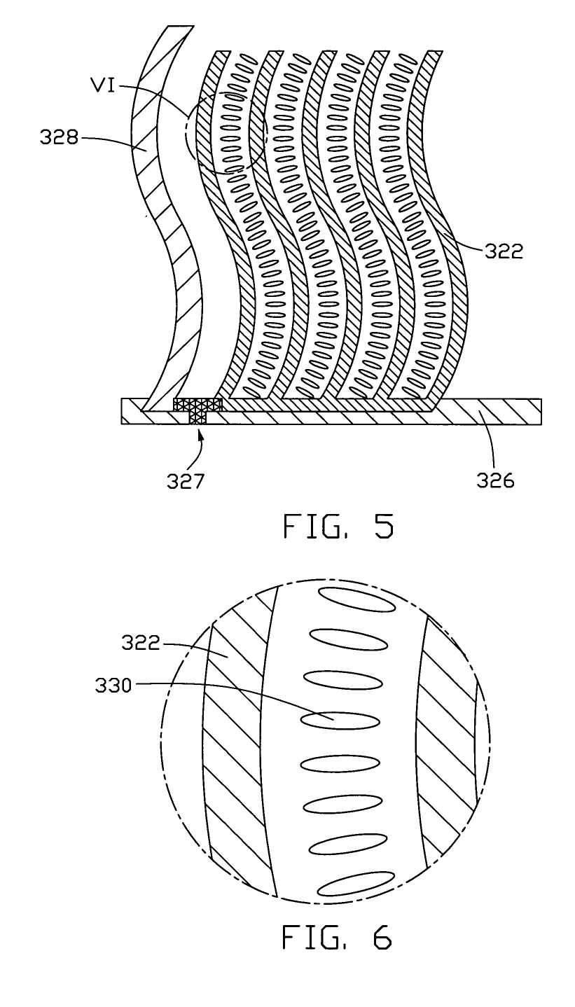

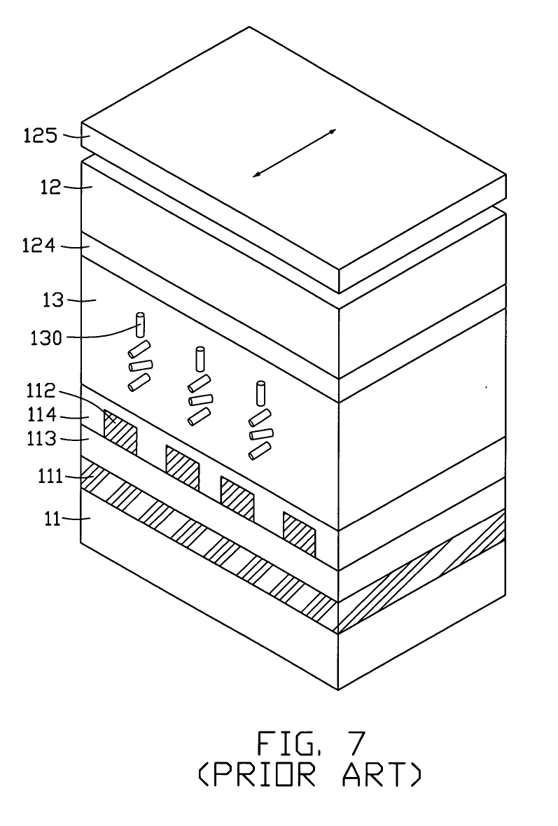

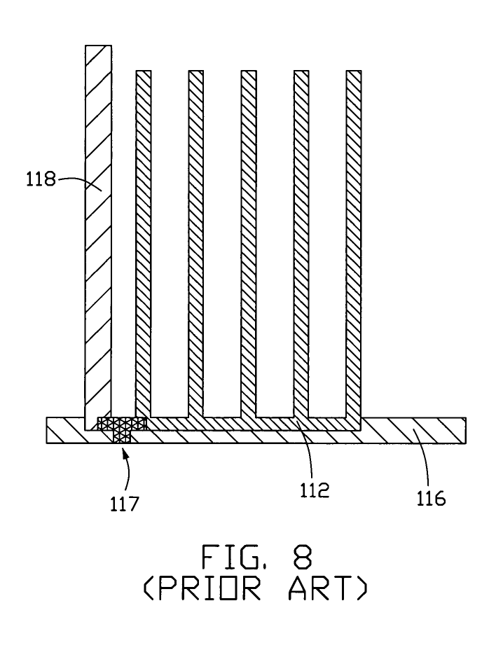

Referring to FIG. 5 and FIG. 6, a gate line 326 and a data line 328 are arranged on the upper substrate 32, and cross each other. A thin film transistor (TFT) 327 is disposed in the vicinity of the crossing of the gate line 326 and the data line 328. The gate line 326 is utilized to control the electrical switching of the TFT 327. The data line 328 provides electrical signals to the pixel electrodes 322. Each pixel electrode 322 has a wave-shaped configuration, with the pixel electrodes 322 being parallel to each other. The data line 328 may also have a wave-shaped configuration, whereby the data line 328 is parallel to the pixel electrodes 322.

When a voltage is applied to the reflective FFS LCD 3, the reflective FFS LCD 3 is in an on state. A fringe electric field distributing in multi-directions is generated between the pixel electrodes 322 and the common electrode 321 so as to form multi-domains. Liquid crystal molecules 330 are twisted so as to align according to the fringe electric field. That is, long axes of the liquid crystal molecules 330 are oriented in multi directions. Accordingly, the reflective FFS LCD 3 has a high quality, reliable display.

In summary, all the above-described configurations of an FFS LCD provide the following structure, function and advantages. In each pixel region, electric fields in at least two directions are generated between the pixel and common electrodes so as to form at least two domains. Accordingly, the FFS LCD has a high quality, reliable display.

It is to be understood, however, that even though numerous characteristics and advantages of embodiments of the present invention have been set forth in the foregoing description, together with details of the structure and function of the embodiments, the disclosure is illustrative only, and changes may be made in detail to the full extent indicated by the broad general meaning of the terms in which the appended claims are expressed.

1. A reflective type fringe field switching liquid crystal display, comprising:
an upper and a lower substrates facing each other;
a liquid crystal layer interposed between the upper and lower substrates;
a plurality of gate lines and a plurality of data lines associated with one of the upper and lower substrates, thereby defining a plurality of pixel regions; and
a common electrode and a plurality of pixel electrodes overlying the common electrode disposed in the pixel regions in order to form at least one fringe electric field, at least one of the pixel electrodes in each pixel region having a bent portion in order to establish an electric field in at least two directions between the pixel electrodes and the common electrode in the pixel region.

2. The reflective type fringe field switching liquid crystal display of claim 1, wherein the bent portion of each of the pixel electrodes has a generally zigzagged configuration.

3. The reflective type fringe field switching liquid crystal display of claim 1, wherein the bent portion of each of the pixel electrodes is wave-shaped.

4. The reflective type fringe field switching liquid crystal display of claim 1, wherein the gate lines and the data lines are associated with the lower substrate.

5. The reflective type fringe field switching liquid crystal display of claim 4, wherein the common electrode is made of reflective material.

6. The reflective type fringe field switching liquid crystal display of claim 5, wherein the common electrode has a plurality of reflective bumps disposed at an inner surface thereof.

7. The reflective type fringe field switching liquid crystal display of claim 4, further comprising a reflective layer disposed between the lower substrate and the common electrode.

8. The reflective type fringe field switching liquid crystal display of claim 7, wherein the reflective layer has a plurality of reflective bumps disposed at an inner surface thereof.

9. The reflective type fringe field switching liquid crystal display of claim 1, wherein the gate lines and the data lines are associated with the upper substrate.

10. The reflective type fringe field switching liquid crystal display of claim 9, further comprising a reflective layer disposed between the lower substrate and the liquid crystal layer.

11. The reflective type fringe field switching liquid crystal display of claim 10, wherein the reflective layer has a plurality of reflective bumps disposed at an inner surface thereof.

12. A reflective type fringe field switching liquid crystal display, comprising:
a first and a second substrates facing each other;
a liquid crystal layer interposed between the first and second substrates; and
a common electrode and a plurality of pixel electrodes overlying the common electrode disposed at one of the first and second substrates in order to form one or more fringe electric fields, at least one of the pixel electrodes having a bent portion.

13. The reflective type fringe field switching liquid crystal display of claim 12, wherein the bent portion has a generally zigzagged configuration.

14. The reflective type fringe field switching liquid crystal display of claim 12, wherein the bent portion is wave-shaped.

15. The reflective type fringe field switching liquid crystal display of claim 12, wherein the common electrode is disposed at the second substrate.

16. The reflective type fringe field switching liquid crystal display of claim 15, wherein the common electrode is made of reflective material.

17. The reflective type fringe field switching liquid crystal display of claim 16, wherein the common electrode has a plurality of reflective bumps disposed at an inner surface thereof.

18. The reflective type fringe field switching liquid crystal display of claim 15, further comprising a reflective layer disposed between the second substrate and the common electrode.

19. The reflective type fringe field switching liquid crystal display of claim 18, wherein the reflective layer has a plurality of reflective bumps disposed at an inner surface thereof.
